(19) United States
(12) Patent Application Publication
(10) Pub. No.: US 2004/0025429 A1
(43) Pub. Date: Feb. 12, 2004

(54) Apparatus and methods for handling and controlling the nurturing of plants

(76) Inventor: Abraham Paulus Houweling, Aldergrove (CA)

Correspondence Address: Lance A. Turlock, Meridian Patent Services, #471-7231-120th Street, Delta, BC, V4C 6P5, CA

(21) Appl. No.: 10/602,018

(22) Filed: Jun. 24, 2003

(30) Foreign Application Priority Data
Jun. 25, 2002 (CA) 2,391,552

(51) Int. Cl. A01C 1/00

(52) U.S. Cl. 47/58.1 R

(57) ABSTRACT

Apparatus for handling and controlling the nurturing of plants comprises a greenhouse for providing a first environmental zone for nurturing plants, a plant warehouse for providing a second environmental zone for nurturing plants, transport rails extending from within the first environmental zone to within the second environmental zone, and a plurality of ebb and flood trays. The first environmental zone is located in the greenhouse in a region positioned to receive substantial amounts of sunlight. The second environmental zone is located in the warehouse in a region substantially sheltered from sunlight.

The ebb and flood trays each include a valve for controlling fluid flow into and out from a flood region within the tray. The valve includes means for receiving a fluid flow from an external source of fluid through a top end of the valve and, in response to the flow, for diverting the flow into the flood region of the tray. Further the valve includes means responsive to the absence of the flow for permitting fluid from the flood region to drain through a bottom end of the valve.

A method of handling and controlling the nurturing of plants in an ebb and flood tray includes the steps of maintaining first and second environmental zones for nurturing plants; maintaining transport rails extending from within the first environmental zone to within the second environmental zone, adapting the tray for riding movement on the rails, positioning the tray on the rails for such movement, and carrying the plants in the tray. The first zone is located in a structure in a region positioned to receive substantial amounts of sunlight. The second zone is located in a structure in a region substantially sheltered from sunlight. At a first time, and if a first prescribed condition is satisfied, the tray with the plants is moved along the rails from within the first environmental zone to within the second environmental zone. At a subsequent time, and if a second prescribed condition is satisfied, the tray with the plants is moved along the rails from within the second environmental zone to within the first environmental zone.

### FIELD OF THE INVENTION

The present invention relates to horticulture and, more particularly, to apparatus and methods for handling and controlling the nurturing of plants on a commercial scale, especially plants that are normally grown in a greenhouse.

### BACKGROUND TO THE INVENTION

The prior art is replete with equipment and systems for handling and controlling the nurturing of greenhouse plants. Known equipment includes plant growing trays or benches that are designed to remain in situ within greenhouses (for example, see U.S. Pat. No. 4,107,875 (Bordine) granted on Aug. 22, 1978; and, U.S. Pat. No. 5,355,618 (Pedersen) granted on Oct. 18, 1994). As well, known equipment includes plant growing trays that are moveable from one location to another on rail systems (for example, see U.S. Pat. No. 3,913,758 (Faircloth et al.) granted on Oct. 21, 1975; U.S. Pat. No. 4,876,967 (Postma) granted on Oct. 31, 1989; and, U.S. Pat. No. 6,164,537 (Mariani et al.) granted on Dec. 26, 2000).

In situ trays like those disclosed by Bordine and Pedersen may be described as ebb and flood trays because they include means for receiving water or other fluid nutrient into a flood region of the tray, and for subsequently draining such nutrient from the flood region. However, the means disclosed often requires connection between the trays and an associated plumbing system. Further, the overall functionality of trays designed to remain in situ obviously is limited because they cannot be used at any other location.

In the case of trays that are moveable along rail systems, they obviously may be used in the differing locations to which the rails extend. But, they generally are not adapted to allow plants to receive water or other nutrient utilizing ebb and flood techniques. Further, they generally are not well adapted for carriage and transport off the rails (e.g. from a greenhouse to a distant marketplace location).

More generally, the prior art also appears not to recognize that the single controlled environment provided by or possible with a greenhouse is not necessarily the most economic place for growing or maintaining greenhouse plants at all times. In the case of Postma, supra, there is recognition that plants from time-to-time may be moved from a greenhouse environment to an uncontrolled outdoor environment, but there is no contemplation of movement to another controlled environment that may be controlled more efficiently than a greenhouse environment.

Accordingly, it is an object of the present invention to provide new and improved apparatus and methods for handling and controlling the nurturing of greenhouse plants, such apparatus providing a controlled environment in addition to a greenhouse environment and which efficiently allows plants to be moved between the respective controlled environments.

A further object of the present invention is to provide new and improved apparatus and methods for handling and controlling the nurturing of greenhouse plants before they are taken to market and, when the plants are ready for market, to allow them to be easily transported to and displayed at a marketplace.

Yet another object of the present invention to provide a new and improved ebb and flood tray that can be efficiently used not only for growing greenhouse plants before they are taken to market, but also for transporting the plants to a marketplace, and for nurturing the plants while at the marketplace.

### BRIEF SUMMARY OF THE INVENTION

In one aspect of the present invention, there is provided apparatus for handling and controlling the nurturing of plants which apparatus comprises a greenhouse for providing a first environmental zone for nurturing plants, a plant warehouse for providing a second environmental zone for nurturing plants, transport rails extending from within the first environmental zone to within the second environmental zone, and a plurality of ebb and flood trays. The first environmental zone is located in the greenhouse in a region positioned to receive substantial amounts of sunlight. The second environmental zone is located in the warehouse in a region substantially sheltered from sunlight. Each tray is adapted to carry plants in a flood region of the tray. Further, each tray is adapted to ride on the rails between the environmental zones.

Such apparatus enables growers to easily move plants back and forth between the environmental zones and to provide nurturing fluids to the plants in a controlled manner. Various nurturing strategies can be executed depending upon internal and external environmental conditions and the needs of the particular plants.

Advantageously, the apparatus further includes couplers or other means for releasably coupling trays in succession for movement along the rails as a train of trays.

In a preferred embodiment, the rails comprise pairs of rails arranged on a number of levels, for example: a first pair of rails on a first level and a second pair of rails on a second level. The second and any subsequent levels are positioned above the first level. As will become apparent, the required size of a plant warehouse with such an arrangment can be significantly less than that of the associated greenhouse. If heating is required, then it may be substantially confined to the smaller warehouse where heating costs will be significantly less.

In a further but related aspect of the present invention, there is provided a method of handling and controlling the nurturing of plants in an ebb and flood tray. The method includes the steps of maintaining first and second environmental zones for nurturing plants; maintaining transport rails extending from within the first environmental zone to within the second environmental zone, adapting the tray for riding movement on the rails (e.g. with rollers, wheels, or the like), positioning the tray on the rails for such movement, and carrying the plants in the tray. The first zone is located in a structure in a region positioned to receive substantial amounts of sunlight (e.g. a greenhouse). The second zone is located in a structure in a region substantially sheltered from sunlight (e.g. a plant warehouse). At a first time, and if a first prescribed condition is satisfied, the tray with the plants is moved along the rails from within the first environmental zone to within the second environmental zone. At a subsequent time, and if a second prescribed condition is satisfied, the tray with the plants is moved along the rails from within the second environmental zone to within the first environmental zone. Such back and forth transport may be carried on for a succession of times, typically once per day until such time as the plants are ready for market.

It will be understood that if two or more ebb and flood trays are coupled in the manner indicated above to form a train of trays, then the methodology can be extended to efficiently handle the back and forth rail movement of several trays of plants at the same time.

Advantageously, the method of the present invention further includes the steps of periodically flooding an ebb and flood tray with a plant nurturing fluid at selected times (typically, daily) at a station located along the rails, and then draining the fluid from the tray while it remains at the station. Preferably the station is located in the second environmental zone (viz. in the warehouse).

In another aspect of the present invention, there is provided apparatus for handling and controlling the nurturing of plants, the apparatus comprising a preferably rectangular ebb and flood tray for carrying the plants and a valve for controlling fluid flow into and out from a flood region within the tray. The valve includes means for receiving a fluid flow from an external source of fluid through a top end of the valve and, in response to the flow, for diverting the flow into the flood region. Further the valve includes means responsive to the absence of the flow for permitting fluid from the flood region to ebb or drain through a bottom end of the valve.

The valve control enables the flood region of a tray to be easily flooded to a desired depth and to automatically drain within a desired time to avoid drowning plants within the tray.

In a preferred embodiment, the valve includes a housing extending through a bottom wall of the tray, the housing comprising upper, lower and intermediate sections. The upper section has an open inlet end for receiving a fluid flow into an interior region of the housing. The lower section has an open outlet end for discharging a fluid flow from the interior region. The intermediate section extends between the upper and lower sections and includes one or more lateral openings which provide a bi-directional fluid flow path between the interior region of the housing and the flood region of the tray. The valve further includes a poppet assembly supported within the interior region to receive a fluid flow force from the received fluid flow. The poppet assembly is responsive to a sufficiently high fluid force flow to move between a normally open condition to a closed condition. In the open condition, fluid in the flood region is permitted to flow out from the flood region along a path through the lateral opening or openings into the interior region, then from the interior region through the outlet end. In the closed condition, fluid flow through the outlet end of the valve is blocked by the poppet. Fluid received by the upper section through the inlet end is then diverted from the interior region into the flood region through the lateral opening or openings. To impair blockage of the fluid flow path by plant debris or other foreign material floating in the fluid, the valve advantageously may include a perforated cage extending peripherally around the valve housing.

The foregoing and other features of the invention will now be described with reference to the drawings.

### BRIEF DESCRIPTION OF THE DRAWINGS

FIG. 1 is a top view of an ebb and flood tray and a valve for controlling fluid flow into and out from the tray in accordance with the present invention.

FIG. 2 is a side elevation view of the apparatus shown in FIG. 1.

FIG. 3 is a fragmented section view, rotated into perspective, taken along section line 3-3 in FIG. 1.

FIG. 4 is a side elevation view of the apparatus shown in FIG. 1, enlarged and sectioned to illustrate details of structure which are hidden or partially hidden from view in FIG. 2.

FIG. 5 is an enlarged detail view of region 5-5 in FIG. 4.

FIG. 6 is an enlarged detail view of region 6-6 in FIG. 4

FIG. 7 is a perspective view illustrating the stacking of a number of trays as shown in FIG. 1.

FIG. 8 is a perspective view illustrating the stacking of a number of trays as shown in FIG. 1 with the addition of spacers between some of the trays.

FIG. 9 is a section elevation view illustrating how a side wall of one tray or spacer as shown in FIG. 8 mates with the side wall of another tray or spacer as shown in FIG. 8 when the two are stacked atop one another.

FIG. 10 is a perspective view of three trays as shown in FIG. 1, each tray riding on a respective pair of transport rails.

FIG. 11 is a perspective view of the trays and rails shown in FIG. 10, the trays now being positioned one above the other on the rails.

FIG. 12 is a top view of two trays as shown in FIG. 1 while riding on a pair of transport rails, the trays being coupled to each other.

FIG. 13 is a side view of one of the couplers shown in FIG. 12.

FIG. 14 is a section elevation view taken along section line 14-14 in FIG. 12.

FIG. 15 is a perspective view of the tray shown in FIG. 1 and of a display table for holding the tray.

FIG. 16 is a perspective view of an alternate ebb and flood tray and a valve for controlling fluid flow into and out from the tray in accordance with the present invention.

FIG. 17 is a side elevation view of the valve forming part of the apparatus shown in FIG. 1, the valve being shown in its normally open condition.

FIG. 18 is a top view of the valve shown in FIG. 17.

FIG. 19 is a bottom view of the valve shown in FIG. 17.

FIG. 20 is an perspective of the housing forming part of the valve shown in FIG. 17.

FIG. 21 is a section elevation view taken along section line 21-21 in FIG. 17. In addition, FIG. 21 shows in detail the connection between the valve and the bottom wall of the tray shown in FIG. 1.

FIG. 22 is a section elevation similar to that shown in FIG. 21. However, in FIG. 22, the valve is shown in its closed condition.

FIG. 23 is a perspective view of the valve shown in FIG. 17 with a perforated cage extending peripherally around the valve housing.

FIG. 24 is an exploded perspective view of the valve and cage structure shown in FIG. 23.

FIG. 25 is a diagrammatic view of a greenhouse and a plant warehouse with several pairs of transport rails as shown in FIGS. 10 and 11 extending within the greenhouse and, although not visible, into the warehouse.

FIG. 26 is a schematic representative of the greenhouse and warehouse shown in FIG. 25. The schematic depicts the positioning of ebb and flood trays within the greenhouse. Further the schematic depicts stations within the warehouse where trays may be flooded with plant nurturing fluid.

FIG. 27 is a schematic as in the case of FIG. 26. However, the ebb and flood trays are now positioned within the warehouse.

FIG. 28 is a fragmentary perspective view showing a pair of ebb and flood trays positioned at successive stations in the plant warehouse for flooding with a plant nurturing fluid and subsequently for allowing such fluid to be drained.

### DETAILED DESCRIPTION

Tray Construction

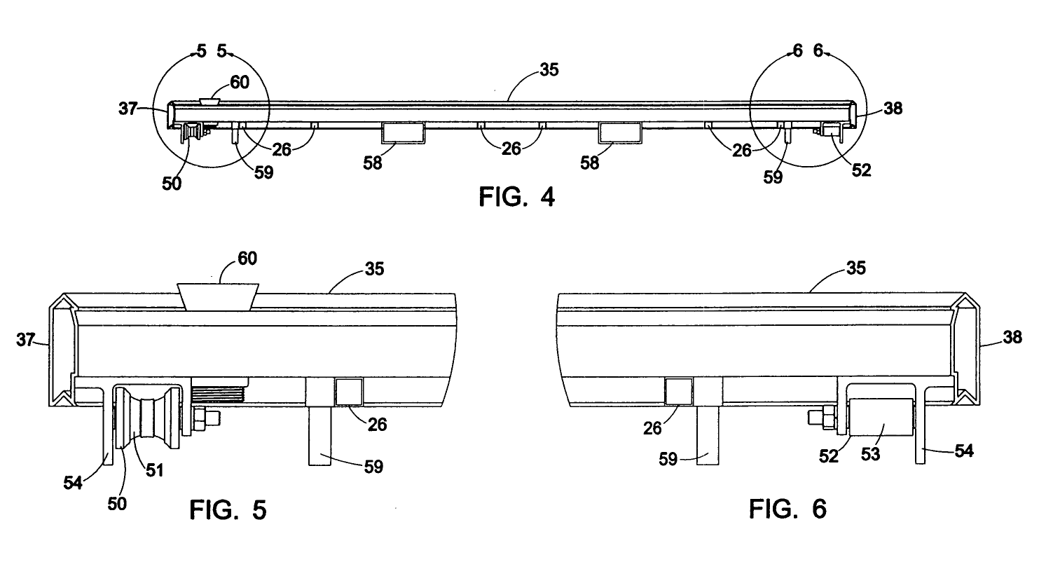

Referring now to the figures, there is shown a rectangular ebb and flood tray generally designated 30 (in some cases 30a, 30b, 30c, etc.) comprising a bottom wall 31 and side walls 35, 36, 37, 38 bounding a flood region 45 within the tray. Bottom wall 31 is part of a pan generally designated 25. Pan 25 is snap fitted within the inside perimeter of walls 35, 36, 37, 38 and is carried by rectangular tubular braces 26 which are secured to and extend at spaced intervals (see FIG. 4) between walls 35 and 36.

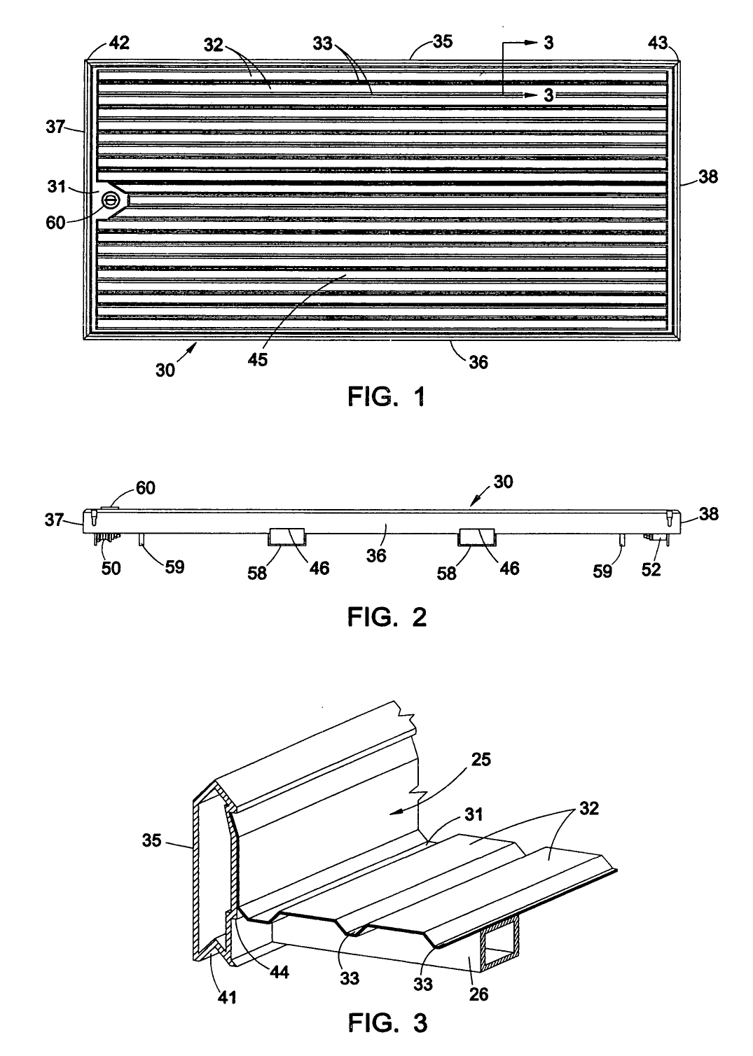

As best seen in FIG. 3, bottom wall 31 has a corrugated structure formed by a series of parallel spaced ribs 32 and furrows 33. Ribs 32 provide a slight elevation for plant growing pots or other containers normally carried in tray 30. Typically, such containers will have holes or other openings in their bottom or lower end portions through which plant nurturing fluid (e.g. water or water with added nutrients) can be absorbed into the containers. Ribs 32 permit fluid in tray 30 to flow beneath as well as around the containers. Also, they guard against the pooling of water around the bottoms of the containers.

It should be noted that the trays designated 30a, 30b, 30c, etc. are substantially the same in construction as tray 30. Where appropriate, the letter designations a, b, c, etc. have been added to more easily distinguish one tray from the other in the discussion that follows.

Wall 36 includes a pair of pallet grooves 46. Wall 35, which is constructed substantially the same as wall 36, has a corresponding pair of pallet grooves which are aligned with grooves 46. Immediately behind each pallet groove, a pallett bracket 58 is secured to wall 35 or 36, as the case may be.

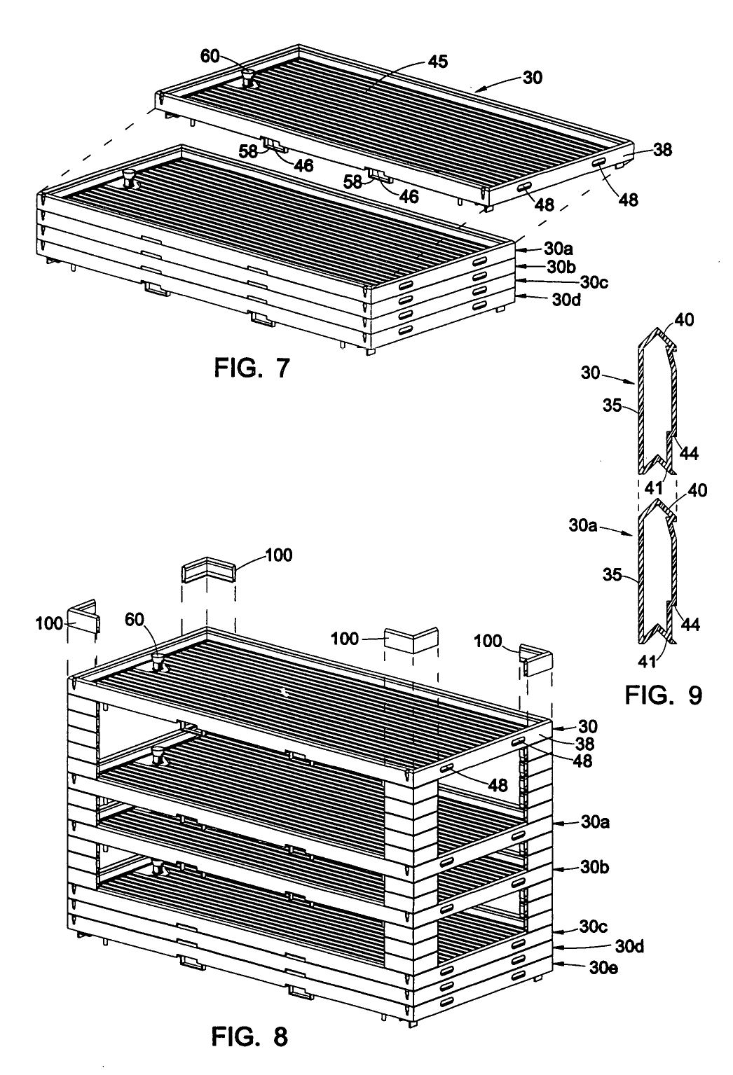

Pallet grooves 46 and brackets 58 are positioned and sized to receive the tines of a conventional fork-lift (not shown). Thus, the distance between grooves in a given wall necessarily corresponds to the distance between the fork-lift tines, and the width of the grooves necessarily is greater than the width of the fork-lift tines. As well, the height of the grooves preferably is greater than the thickness of the fork-lift tines. This not only enables tray 30 to be lifted and carried by a fork-lift, but also enables several of such trays to be stacked or unstacked in the manner shown in FIGS. 7-9 with the aid of the fork-lift. Note also that in the stacked conditions shown in FIGS. 7-9, several trays 30 may be carried simultaneously when the fork-lift is engaged with the lowermost tray.

It should be noted that brackets 58 are sized to provide a base for tray 30 when the tray is positioned on a flat surface. Added support on a flat surface is provided by four downwardly extending cylindrical legs 59, the primary purpose of which is discussed hereinafter. Two of legs 59 are secured to wall 35 and two are secured to wall 36. (The bottoms of brackets 58 and the bottoms of legs 59 are all at the same level. From FIGS. 2 and 4, it will be seen that these bottoms lay below all other parts of tray 30.)

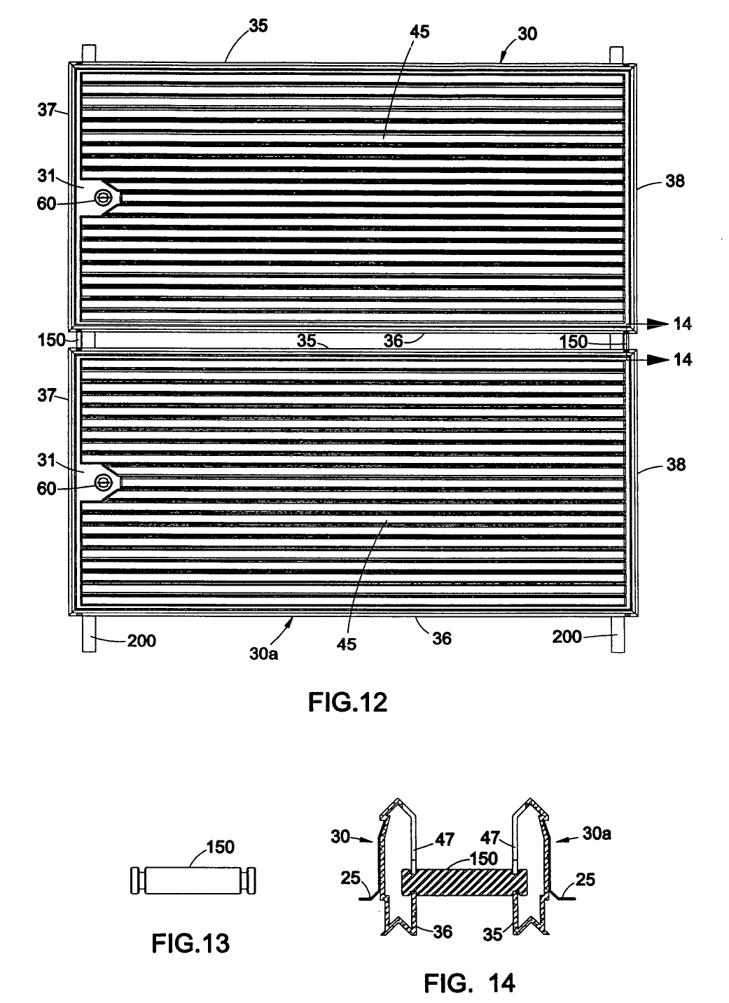

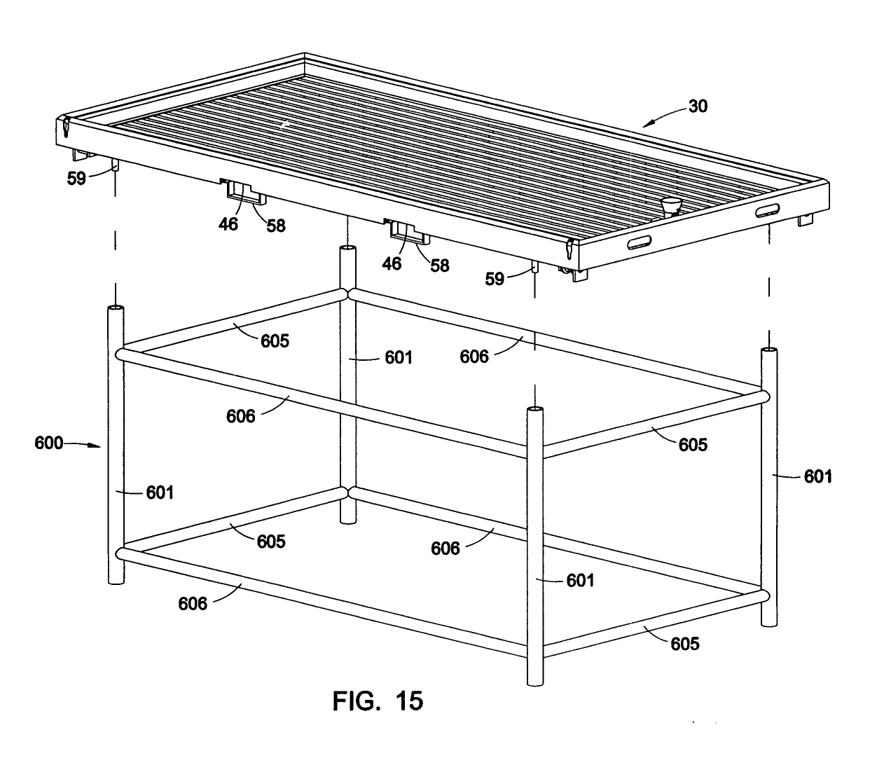

Wall 36 of tray 30 also includes a pair of coupler slots 47 in the wall. Wall 35 has a corresponding pair of coupler slots which are aligned with slots 47. Each coupler slot is sized to receive one end of a cylindrical coupler 150 as shown in FIG. 13 in the manner indicated in FIG. 14 thereby enabling one tray 30 to be coupled to another tray 30a in the manner indicated in FIG. 12. In combination, such coupler slots 47 and couplers 150 provide a means for releasably coupling trays 30, 30a in succession to ride on transport rails as described below.

Wall 38 includes a pair of handhold openings 48. Wall 37 is constructed in substantially the same manner and has a corresponding pair of handhold openings (not shown). Openings 48 allow workers to more easily lift tray 30 should they choose to do so instead of using a fork-lift.

Details of wall construction can be seen in FIGS. 3, 9 and 14. As shown by way of example in FIGS. 3 and 9, wall 35 is a hollow extrusion having a top 40 shaped in the form of an inverted V and a bottom 41 also shaped in the form of an inverted V. The cross-section of the wall is uniform along its full length except at extreme ends 42, 43 (see FIG. 1), and except where pallet grooves 46 and slots 47 (see e.g. FIG. 14) are cut in the wall. Extreme ends 42, 43 of wall 35 are cut at a 45 degree angle to abut with correspondingly cut ends of walls 37, 38. Note that top 40 and bottom 41 are cooperative shapes. More particularly, and as illustrated by the example of FIG. 9, the inverted V-shaped top 40 of wall 35 of tray 30a is shaped to vertically mate with the inverted V-shaped bottom 41 of wall 35 of tray 30. The structural detail of wall 36 is the same as wall 35.

Except in the region of handhold openings 48, walls 37, 38 have the same basic cross-section as that shown in FIGS. 3, 9 for wall 35. This includes an inner downwardly facing ridge 44 which serves during assembly of tray 30 as an abutment for braces 26.

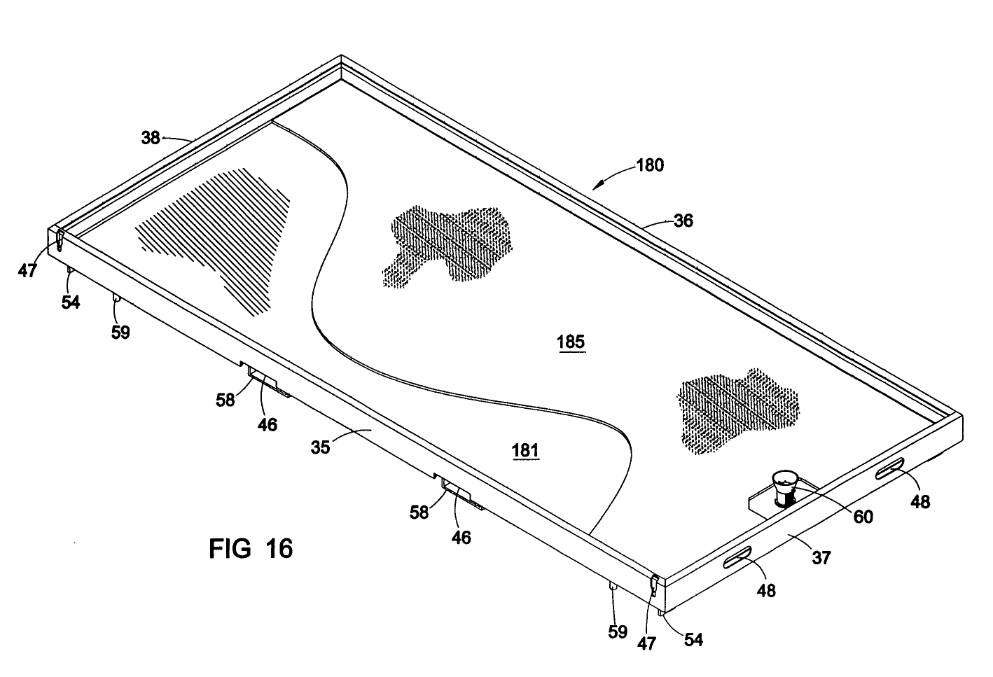

Those skilled in the art will appreciate that other designs of ebb and flood trays within the scope of the present invention are possible. For example, FIG. 16 illustrates an ebb and flood tray generally designated 180 which is substantially the same as tray 30, except as follows:

(1) Pan 25 which forms part of tray 30, and which has a corrugated bottom wall 31, has been replaced with a pan which has a flat bottom wall 181.

(2) A layer of conventional capillary matting 185 has been placed on top of bottom wall 181. (In FIG. 16 part of such matting has been cut-away for the purpose of illustration). In use, the matting serves to distribute moisture and to guard against the pooling of water around the bottoms of plant growing pots or other containers carried in tray 180.

Generally, an ebb and flood tray such as tray 30 having a corrugated bottom wall is preferred over an ebb and flood having a flat bottom wall and capillary matting. However, the tatter are less costly and easier to manufacture.

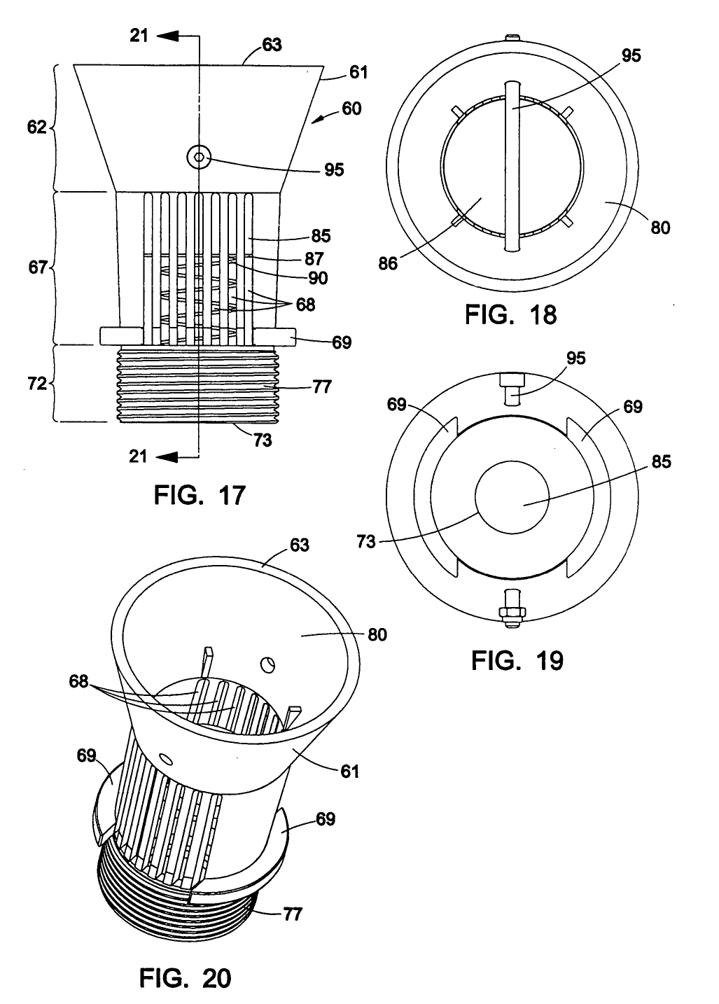

A valve 60 extends through bottom wall 31 of tray 30 for controlling fluid flow into and out from flood region 45. As shown in detail in FIGS. 17-22, valve 60 includes a housing 61 comprising:

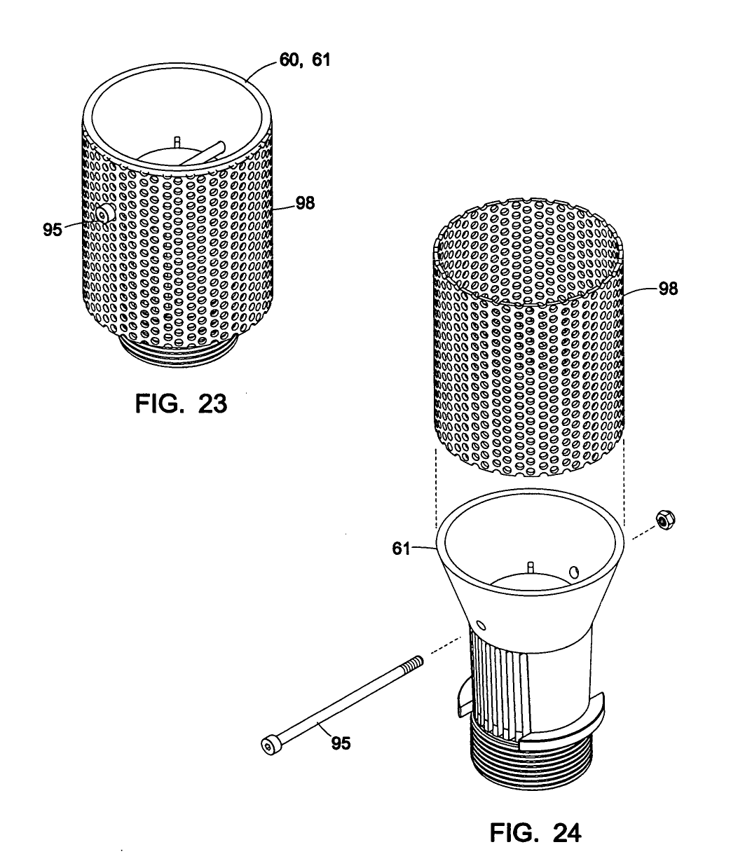

an upper section 62 having an open inlet end 63 for receiving a fluid flow into an interior region 80 of the housing (viz. as indicated by arrows F1 in FIG. 22);

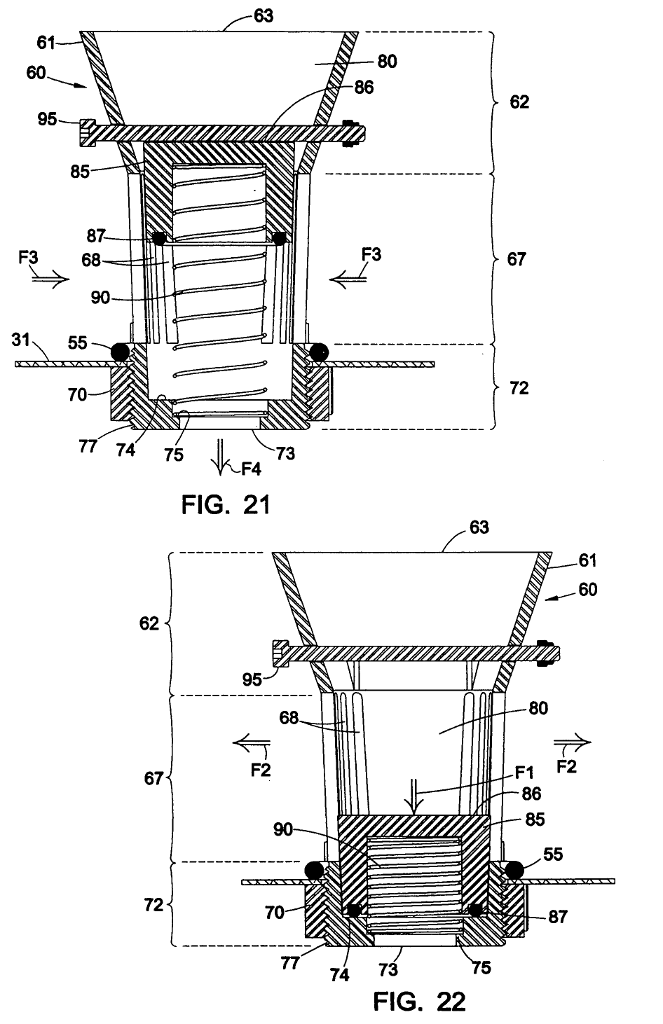

a lower section 72 having an open outlet end 73 for discharging a fluid flow from interior region 80 (viz. as indicated by arrow F4 in FIG. 21); and,

an intermediate section 67 extending between upper and lower sections 62, 72.

Intermediate section 67 includes a plurality of elongated vertically extending lateral openings or slot 68 for providing a bi-directional fluid flow path between interior region 80 of valve 60 and flood region 45 of tray 30. As well, intermediate section 67 includes a split flange 69.

As best seen in FIGS. 21-22, valve 60 further includes a poppet assembly supported within interior region 80. The assembly comprises an overall cylindrically shaped plug 85 having an upper surface 86 and a bottom end fitted with an O-ring seal 87. Surface 86 is positioned to receive the force of a fluid flow as indicated by arrows F1 in FIG. 22. Seal 87 is seatable on an annular seating 74 disposed within lower section 72 of housing 61. The poppet assembly further comprises a compression spring 90 seated at its lower end on an annular flange 75 which extends radially inward from seating 74 to define the opening in outlet end 73.

As shown in FIGS. 21-22, valve 60 is secured to bottom wall 31 by means of a ring nut 70 and an O-ring seal 55. Nut 70 engages threads 77 of housing 61 immediately below wall 31. Seal 55 encircles housing 61 immediately below split flange 69 and immediately above bottom wall 31. When nut 70 is tightened, seal 55 is compressed between flange 69 and bottom wall 31 thereby providing a fluid seal between flood region 45 and the opening in bottom wall 31 through which housing 61 extends.

Valve 60 also includes a removable retainer or bolt 95 which normally extends diametrically across upper section 62 of housing 61. Its purpose is to prevent the poppet assembly from inadvertently falling out of housing 61 when valve 60 is handled separately from tray 30 or in the event that the valve is tipped over with tray 30.

In some cases, it may be found that slots 68 are prone to blockage by plant debris (twigs, leaves, etc.) or other foreign material floating in flood region 45 of tray 30. To impair such blockage, valve 60 advantageously may include a perforated cage 98 sized to extend peripherally around the valve housing 61 as shown in FIGS. 23-24. It will be noted that bolt 95 mentioned above is used to secure the cage.

Tray 30 is adapted for riding movement on a pair of cylindrical pipe transport rails by means of wheels or rollers 50, 52 mounted on brackets 54 below bottom wall 31 to the interior sides of walls 37, 38. One pair of such rollers 50, 52 is positioned in axial alignment near wall 36 and another such pair is positioned in axial alignment near wall 35.

As best seen in FIGS. 5-6, roller 50 is configured with a cylindrically concave riding surface 51 whereas roller 52 is configured with a cylindrically flat riding surface 53. The concave radius of surface 51 is sized to correspond with the pipe radius of transport rails 200. When riding on a rail, roller 50 and therefore tray 30 is thereby restrained against transverse movement in relation to the rail, and will remain centered atop the rail as it moves along the rail. In contrast, flat surface 53 will permit transverse sliding movement of roller 52 relative to a rail on which it rides. Thus, while roller 50 moves along centered on one rail, roller 52 may move along either centered or slightly off center on the other rail. Within obvious limits, the combination of concave and flat roller surfaces allows a tray 30 to be transported along a pair of rails by rollers 50, 52 despite possible variations in the precise distance between the rails.

### EXAMPLE

In a representative example, tray 30 is about 93 inches (236 cm) in length and about 45 inches (114 cm) in width. Side walls 35, 36, 37, 38 are fabricated from aluminum and welded where their ends meet. The overall height of the side walls is about 4 inches (10 cm) and their overall thickness is about 1 inch (2.5 cm). The aluminum thickness is about ⅛ inch (3 mm). The inverted V shape of top 40 and bottom 41 each have a height of about ½ inch (13 mm). Pan 25 is fabricated from 0.050 inch (1.3 mm) sheet aluminum. Flood region 45 can carry water to a depth in excess of 2.5 inches (6.3 cm).

Valve housing 61 is fabricated from plastic having a wall thickness of about ⅛ inch (3 mm) and an overall height of about 4 inches (10 cm). The outer diameter of the top end is about 2⅞ inches (7.3 cm). The outer diameter of intermediate section 67 (exclusive of flange 69) and lower section 72 (exclusive of threads 77) is about 1¾ inches (4.4 cm). Split flange 69 projects radially outward about ¼ inch (6 mm) from the remaining part of intermediate section 67. The opening at outlet end 73 has a diameter of about ⅞ inches (2.2 cm).

Stacking of Trays

As illustrated in FIG. 7, trays 30 may be stacked directly atop one another. Trays 30a to 30d have already being stacked. Tray 30 is in the process of being added to the stack. Generally, such stacking is useful for the purpose of storage and for the purpose of transporting a number of trays from one location to the other. When stacked, the mating of the tops and bottoms of the walls as described above in relation to FIG. 9 contributes to a relatively stable overall structure where the trays cannot easily shift or slide across the tops of one another. In other words, relative horizontal movement between the trays is restrained. This feature is particularly desirable during transport from one location to another.

As illustrated in FIG. 8, trays 30 may also be stacked either directly atop one another as in the case of trays 30c to 30e, or with vertical space between selected trays as in the case of trays (30, 30a), (30a, 30b) and (30b, 30c). Such stacking is facilitated with the use generally L-shaped spacers 100 conveniently and preferably fabricated from the same stock as is used to fabricate walls 35, 36, 37, 38. Spacers 100 then will have the same general cross-section as the walls, including inverted V-shaped tops and bottoms 40, 41, as illustrated in FIG. 9. Thus, just as the walls of respective trays will mate with each other to restrain relative horizontal movement, the walls of the spacers will mate with the walls of other spacers or the walls of selected trays to restrain relative horizontal movement.

Stacking with space between trays allows a number of trays to carry plants while stacked. This attribute is particular useful when transporting plants from a greenhouse where the trays are used to a marketplace where the trays will continue to be used. The vertical space between any two trays can be varied with spacers 100 to best accommodate the height of the plants in the lower tray.

Adding to the representative example given above, suitable spacers 100 would have an overall height of about 4 inches as in the case of walls 35, 36, 37, 38. The foot or short side of the L-shape extends for about 6½ inches and the back or long side of the L-shape extends for about 20 inches. With such dimensions and with stacking as shown in FIG. 8, the space between trays 30 and 30a with five tiers of spacers would be about 20 inches, the space between trays 30a and 30b with two tiers of spacers would be about 8 inches, and the space between trays 30b and 30c with three tiers of spacers would be about 12 inches.

As shown in FIG. 15, legs 59 of tray 30 also enable the tray to be held by a cooperatively designed display table generally designated 600. More particularly, table 600 comprises four corner posts 601 formed from hollow pipes, each pipe having an inside diameter sized to sliding receive one of the legs. The posts are stablized and secured by upper and lower horizontal rails 605, 606 extending between the posts. It should be noted that upper rails 606 are distanced below the tops of posts 601 so as not to conflict with pallet brackets 58.

Transport Rail System

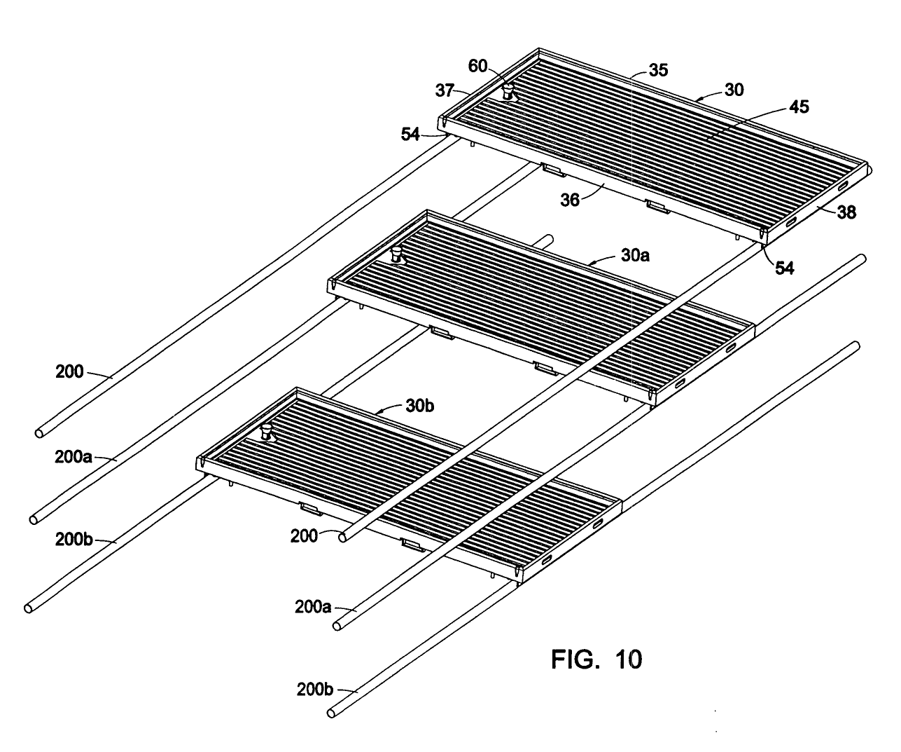

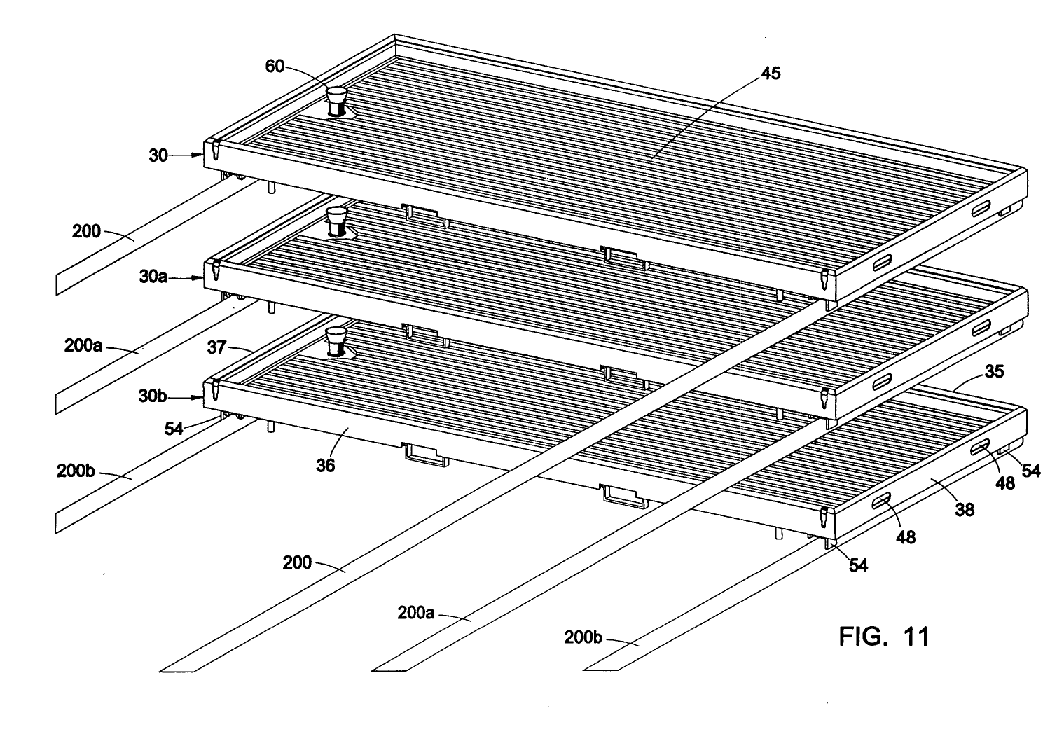

FIGS. 10-12 each show a tray 30 being carried on a pair of transport rails 200 (viz. on rollers 50, 52 as described above). In the case of FIG. 12 two trays 30, 30a coupled by couplers 150 are being carried simultaneously. In practice, many trays may be coupled in the manner shown in FIG. 12. When coupled, the trays may be moved back and forth along rails 200 as a train of trays.

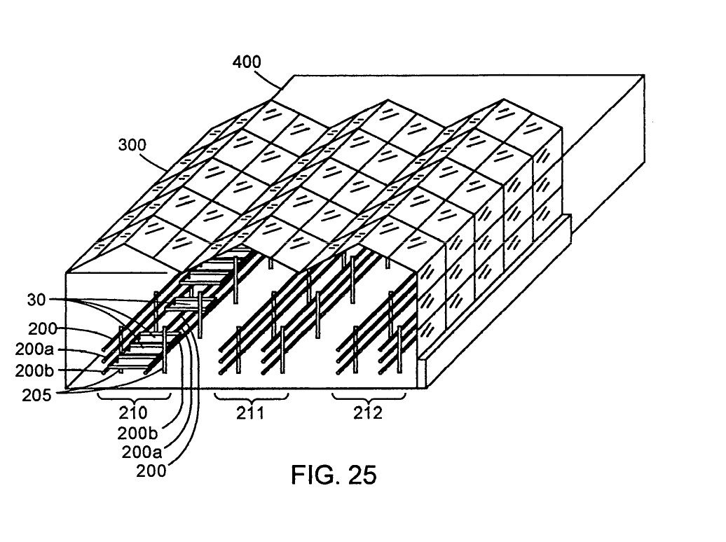

Referring now to FIG. 25, there is shown a greenhouse 300 and a warehouse 400. Greenhouse 300 is a conventional glassed enclosure that provides a first environmental zone for nurturing plants. Here, plants may be positioned to receive substantial amounts of sunlight. Warehouse 400 is a structure which is built in a conventional way and which provides a second environmental zone for nurturing plants. The second environmental zone is substantially sheltered from sunlight by the opaque roof and walls of warehouse 400.

Warehouse 400 is smaller and more insular than greenhouse 300. Hence, it is more economically heatable than the greenhouse.

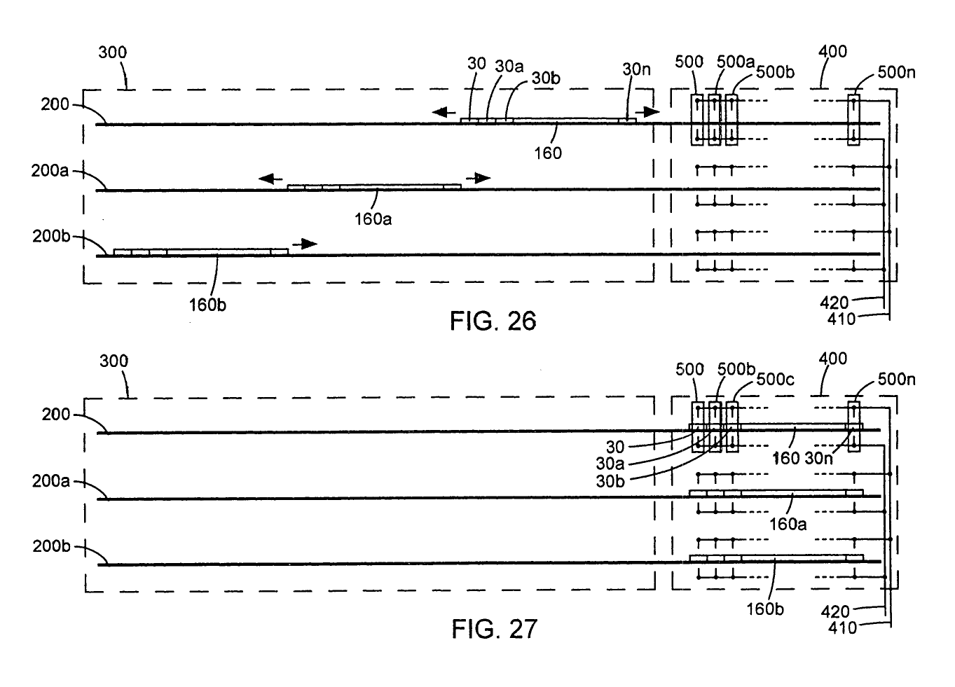

As shown in FIG. 25, several pairs of rails arranged in groups 210, 211 and 212 are present. Each group includes three pairs of rails (200, 200), (200a, 200a) and (200b, 200b) arranged in levels one above the other supported by a suitable framework 205. All groups extend from within greenhouse 300 to within warehouse 400 in the manner indicated in FIGS. 26-27.

Only some ebb and flood trays are depicted in FIG. 25. But, as representationally shown in FIGS. 26-27, it will be seen that for any one of groups 210, 211 or 212 each level of rails 200, 200a, 200b carries a plurality of ebb and flood trays 30, 30a, 30b, . . . 30n. On each level, the trays are coupled in sequence (viz. by couplers 150 as described above, but not visible in FIGS. 26-27). In effect, the coupling forms trains of trays 160, 160a, 160b which are moveable back and forth on the rails between greenhouse 300 and warehouse 400.

As shown in FIG. 26, each train of trays 160, 160a, 160b within greenhouse 300 is horizontally displaced from the other. Hence, trays 30, 30a, 30b, . . . 30n on one level are not shaded from sunlight by trays on another level. In contrast, when moved to warehouse 400 as shown in FIG. 27, the trains of trays on each level are vertically aligned. Here of course, shading and the absence of sunlight are not an issue.

Since the trains of trays 160, 160a, 160b are vertically aligned in warehouse 400, it follows that the size of the warehouse may be significantly less than the size of greenhouse. In practice, the ultimate difference in size will depend upon the number of rail levels and the length of the trains of trays on each level. Assuming that the length of the trains of trays on each level is the same, then the length of the greenhouse should be at least the length of the warehouse multiplied by the number of levels.

Within the environmental zone provided by warehouse 400, a plurality of stations 500, 500a, 500b, . . . 500n are located at spaced intervals along the rails. Although such stations are depicted only in the case of rails 200, it is to be understood that like stations are also present in the cases of rails 200a and 200b. Each station includes a connection to a main inlet pipe 410 through which plant nurturing is fluid may be supplied. Likewise, each station includes a connection to a main drain pipe 420 through which fluid may be drained. The distance between stations corresponds to the distance between the centers of valves 60 (not shown) of successive trays 30, 30a, 30b, . . . 30n. Thus, when tray 30 in train 160 is at station 500, the successive trays 30a, 30b, . . . 30n in the train will be at successive stations 500a, 500b, . . . 500n.

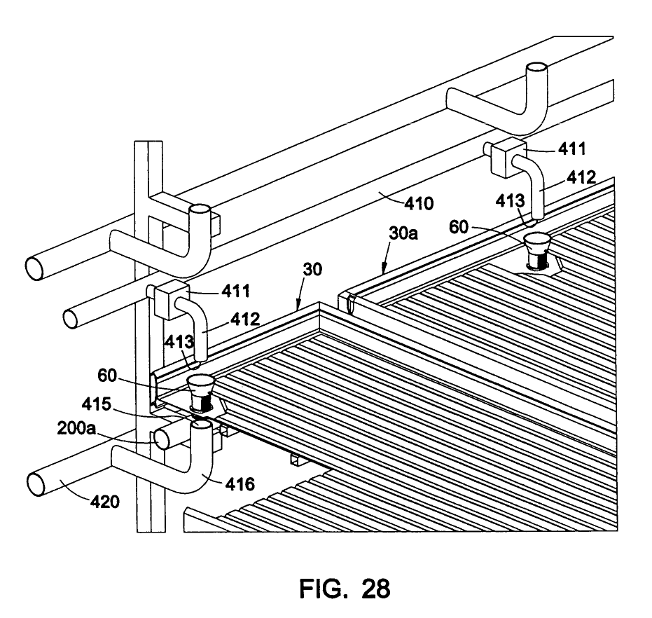

FIG. 28 illustrates features present at two successive stations on the level of tracks 200a in warehouse 400. As well, it illustrates a portion of the lower part of stations located on the level of tracks 200 (not shown) immediately above the stations on tracks 200a. Each station on the level of tracks 200a includes a tap line 412 connected to a common inlet pipe 410, and a drainage line 416 connected to a common drain pipe 420. Fluid flow through line 412 is controlled by a valve 411. When fluid is allowed by valve 411 (which may be controlled mannually or electrically) to flow through line 412 from pipe 410, it exits from outlet end 413 vertically downward. Normally, valve 60 of a properly stationed tray 30 will be aligned directly below end 413 to receive the flow. Drainage line 416 includes an inlet end 415 which is aligned directly below end 413. Thus, when fluid drains from tray 30 through valve 60 of a properly stationed tray, it is captured by line 416 and delivered to drain pipe 420.

FIG. 28 is a fragmentary perspective view showing a pair of ebb and flood trays positioned at successive stations in the plant warehouse for flooding with a plant nurturing fluid and subsequently for allowing such fluid to be drained.

Operations

The operation of valve 60 whether in conjunction with a transport rail system or otherwise, will be best understood with reference to FIGS. 21-22. More particularly, in the absence of a fluid flow downwardly through open end 63, plug 85 will be biased by spring 90 upwardly within housing 61 away from seating 74 to the upper or normally open condition shown in FIG. 21. In this condition, and as indicated by arrows F3, F4 in FIG. 21, fluid is permitted by the poppet assembly to ebb or drain out from flood region 45 along a path laterally through slots 68 into interior region 80 of housing 61, then from interior region 80 through open outlet end 73. Conversely, and in response to a sufficiently high fluid flow force through open end 63 as indicated by arrows F1 in FIG. 22, plug 85 will be urged against the bias of spring 90 to the lower or normally closed condition shown in FIG. 22. In this condition, the escape of fluid through open outlet end 73 is blocked by plug 85. Thereafter, and as indicated by arrows F2, fluid received in upper section 62 through open inlet end 63 is diverted by the poppet assembly (in particular, plug 85) from interior region 80 into flood region 45 through slots 68. The timing of a flood and ebb cycle will depend upon considerations well known to horticulturists, but typically will be a very few minutes.

In conjunction with the transport rail system shown in FIGS. 25-28, valve 60 of each tray 30, 30a, 30b, . . . 30n is operated in the manner described above with reference to FIG. 28. By opening valve 411 for a given tray when at its associated station 500, 500a, 500b . . . 500n, plant nurturing fluid is supplied from inlet pipe 410 through tap line 412 to the tray thereby closing valve 60 of the tray for a period of time required to flood the tray to a desired depth. The actual time during which flooding is allowed to occur may be controlled by manual or automatic control of valve 411 for the tray. When the fluid supply for the tray is turned off by turning off associated valve 411, valve 60 of the tray reverts to its normally open condition. Fluid then is permitted to drain through drainage line 416 of the tray and thence to drain pipe 420.

It will be recognized that on any given rail level it is not essential to have a separate station 500, 500a, 500b, . . . 500n in warehouse 400 for each tray 30, 30a, 30b, . . . 30n. Only one station in the position of station 500 would suffice. Then, as a train of trays such as train 160 was moved from greenhouse 300 to warehouse 400, the train could be stopped as each tray entered station 500 to allow the specific tray to be flooded and drained. The first tray would be tray 30n. The last would be tray 30. Facilities like those shown in FIG. 28 would not be necessary at stations 500a, 500b, . . . 500n. However, it also will be recognized that the provision of only one station 500 on each level could significantly impair efficiency.

The conditions determining when plants carried by trays 30, 30a, 30b, . . . 30n should be nurtured with suitable fluid, or whether they should moved from the environmental zone provided by greenhouse 300 to the environmental zone provided by warehouse 400, will depend on various factors known to persons skilled in the art. By way of example, such factors may include the type of plants, their stage of growth or height, and the anticipated market date for the plants. Others may include the availability of sunlight and the desired duration of exposure to sunlight from day to day, outside temperatures, and the economics of maintaining a desired temperature in one environmental zone as opposed to another.

Through the provision of apparatus for handling and controlling the nurturing of plants as described above, the present invention enables growers to plan and easily execute various nurturing strategies. For example, if a first prescribed condition is satisfied, trays 30, 30a, 30b, . . . 30n may be moved along rails 200 from within the environmental zone provided by greenhouse 300 to the environmental zone provided by warehouse 400. The first condition may be as basic as night time is approaching and/or that it is time for the plants to be watered at stations 500, 500a, 500b . . . 500n with a suitable nurturing fluid. Or, for example, the condition may be that the plants are no longer receiving any useful amount of sunlight in the greenhouse and/or that they should be moved to a warmer, heated environment in the warehouse. Subsequently, if a second prescribed condition is satisfied, the plants may be moved back along rails 200 from the environmental zone provided by warehouse 400 to the environmental zone provided by greenhouse 300. Such back and forth movement may carry on repeatedly for days or weeks until the plants are ready for market.

Trays 30, 30a, 30b, . . . 30n not only facilitate the handling and nurturing of plants while they are growing in environmental zones provided by greenhouse 300 and warehouse 400, but also facilitate continued handling and nurturing during transport to and presentation for sale in a marketplace. More particularly, without removing the plants from the trays, the trays can be lifted from rails 200 with the aid of a fork-lift and stacked in one or more stacks in the manner indicated in FIG. 8 in a truck or other transport vehicle. Upon arrival at the marketplace, the trays can be unstacked in a similar manner, and each tray can be set on a display table such as table 600 (FIG. 15). At the marketplace, at prescribed times, the trays can be individually flooded with water or other plant nurturing fluid and allowed to drain through their valves 60 as if they were at a station 500 in warehouse 400. As the plants are sold, the trays can be moved from the display tables and stacked in the manner indicated in FIG. 7 where they are ready for transport back to greenhouse 300 and warehouse 400 for reuse.

Thus, trays 30, 30a, 30b, . . . 30n efficiently allow plants to be taken from a greenhouse or warehouse to a marketplace and to be displayed at the marketplace without a need to individually handle the plants or their growing pots. Further, it is to be noted that trays 30, 30a, 30b, . . . 30n provide a more suitable means for tending to the well-being of plants while they are on display in the marketplace. In this regard, it will be understood that many marketplace outlets are not necessarily staffed with personnel who are knowledgeable about the nurturing of plants. These outlets include grocery stores, supermarkets, general retail outlets and the like. Not untypically, the plants will not be provided with a suitable amount of water or other nurturing fluid at desirable times. The process is largely uncontrolled and the plants tend to deteriorate prematurely. The result can be a significant amount of wastage. Trays such as trays 30, 30a, 30b, . . . 30n enable the process to be controlled more reliably. Unskilled workers do not need to guess when the degree of watering is sufficient—missing some plants and perhaps drowning others. They merely need instruction on flooding each tray to a prescribed depth at prescribed time.

Variations

A variety of modifications, changes and variations to the invention are possible within the spirit and scope of the following claims, and will undoubtedly occur to those skilled in the art. The invention should not be considered as restricted to the specific embodiments that have been described and illustrated with reference to the drawings.

I claim:

1. Apparatus for handling and controlling the nurturing of plants, said apparatus comprising:
(a) a greenhouse for providing a first environmental zone for nurturing plants, said first zone being located in said greenhouse in a region positioned to receive substantial amounts of sunlight;
(b) a plant warehouse for providing a second environmental zone for nurturing plants, said second zone being located in said warehouse in a region substantially sheltered from sunlight;
(c) transport rails extending from within said first environmental zone to within said second environmental zone; and,
(d) a plurality of ebb and flood trays, each adapted to carry plants in a flood region of the tray, and each adapted to ride on said rails between said environmental zones while carrying said plants.

2. Apparatus as defined in claim 1, further including means for releasably coupling said trays in succession for movement along said rails as a train of trays.

3. Apparatus as defined in claim 1, further including couplers for releasably coupling said trays in succession for movement along said rails as a train of trays.

4. Apparatus as defined in claim 1, wherein said rails comprise:
(a) a first pair of rails on a first level; and,
(b) a second pair of rails on a second level, said second pair of rails being positioned above said first pair of rails.

5. A method of handling and controlling the nurturing of plants in an ebb and flood tray, said method comprising the steps of:
(a) maintaining first and second environmental zones for nurturing plants, the first of said zones being located in a structure in a region positioned to receive substantial amounts of sunlight, the second of said zones being located in a structure in a region substantially sheltered from sunlight;
(b) maintaining transport rails extending from within said first environmental zone to within said second environmental zone;
(c) adapting said tray for riding movement on said rails;
(d) positioning said tray on said rails for such movement;
(e) carrying said plants with said tray;
(f) at a first time, and if a first prescribed condition is satisfied, moving said tray with said plants along said rails from within said first environmental zone to within said second environmental zone;
(g) at a subsequent time, and if a second prescribed condition is satisfied, moving said tray with said plants along said rails from within said second environmental zone to within said first environmental zone; and,
(h) repeating steps (f) and (g) at a succession of times.

6. A method as described in claim 5, wherein:
(a) said structure in which said first environmental zone is located comprises a greenhouse; and,
(b) said structure in which said second environmental zone is located comprises a plant warehouse.

7. A method as defined in claim 5 or 6, further comprising:
(a) flooding said tray with a plant nurturing fluid at selected times at a station located along said rails; and,
(b) then draining said fluid from said tray at said station.

8. A method as described in claim 5 wherein said structure in which said first environmental zone is located comprises a greenhouse; and wherein said structure in which said second environmental zone is located comprises a plant warehouse; said method further comprising the steps of:
(a) flooding said tray with a plant nurturing fluid at selected times at a station located along said rails in said warehouse; and,
(b) after a predetermined time draining said fluid from said flooded tray at said station.

9. Apparatus for handling and controlling the nurturing of plants, said apparatus comprising an ebb and flood tray for carrying said plants and a valve for controlling fluid flow into and out from a flood region within said tray, said valve comprising:
(a) a housing extending through a bottom wall of said tray, said housing comprising:
(i) an upper section having an open inlet end for receiving a fluid flow into an interior region of said housing;
(ii) a lower section having an open outlet end for discharging a fluid flow from said interior region; and,
(iii) an intermediate section extending between said upper and lower sections; said intermediate section comprising at least one lateral opening for providing a bi-directional fluid flow path between said interior region and said flood region;
(b) a poppet assembly supported within said interior region to receive a fluid flow force from said received fluid flow, said poppet assembly being responsive to a sufficiently high fluid flow force to move between:
(i) a normally open condition whereat fluid in said a flood region is permitted by said poppet assembly to flow out from said a flood region along a path through said at least one lateral opening into said interior region, then from said interior region through said outlet end; and,
(ii) a closed condition whereat fluid flow through said outlet end is blocked by said poppet assembly and fluid received by said upper section through said inlet end is diverted by said poppet assembly from said interior region into said flood region through said at least one lateral opening.

10. Apparatus as defined in claim 9, wherein:
(a) said housing includes an annular seating disposed within said lower section; and,
(b) said poppet assembly comprises:
(i) a plug seatable on said seating, said plug including a surface positioned to receive said fluid flow force; and,
(ii) a compression spring for biasing said plug upwardly from said seating.

11. Apparatus as defined in claim 9 or 10, wherein said at least one lateral opening comprises a plurality of elongated vertically extending slots.

12. Apparatus as defined in claim 9, further comprising a perforated cage extending peripherally around said housing for impairing blockage of said fluid flow path by foreign material floating in the fluid.

13. Apparatus for handling and controlling the nurturing of plants, said apparatus comprising:
(a) a generally rectangular ebb and flood tray, said tray comprising a bottom wall and side walls bounding a flood region within said tray; and,
(b) a valve extending through said bottom wall for controlling fluid flow into and out from said flood region, said valve comprising:
(i) means for receiving a fluid flow from an external source of fluid through a top end of said valve and, in response to said flow, for diverting said flow into said flood region; and,
(ii) means responsive to the absence of said flow for permitting fluid in said flood region to drain through an outlet end of said valve.

14. Apparatus as defined in claim 12, said apparatus further comprising transport rails for carrying said tray between selected stations along said rails, said tray being adapted to ride on said rails, one of said stations including a fluid outlet facility positioned to discharge fluid from said external source downwardly through said top end of said valve when said tray is at said station on said rails.

15. Apparatus as defined in claim 13, wherein said tray includes pallet grooves positioned and sized to receive a pair of fork-lift tines.

16. Apparatus for handling and controlling the nurturing of plants, said apparatus comprising:
(a) transport rails;
(b) a plurality of generally rectangular ebb and flood trays, each tray adapted to ride on said rails, and each tray comprising a bottom wall and side walls bounding a flood region within the tray;
(c) couplers for releasably coupling said trays in succession for movement along said rails as a train of trays; and,
(d) a plurality of valves, each associated with an associated one of said trays, and each extending through the bottom wall of the associated tray for controlling fluid flow into and out from the flood region of the associated tray; each valve comprising:
(i) means for receiving a fluid flow from an external source of fluid through a top end of said valve and, in response to said flow, for diverting said flow into the flood region of the associated tray; and,
(ii) means responsive to the absence of said fluid flow for permitting fluid in the flood region of the associated tray to drain through an outlet end of the valve.

17. Apparatus as defined in claim 15, wherein said side walls of each of said trays have a top shaped to mate with a cooperatively shaped bottom of a corresponding side wall of any selected other one of said trays, thereby permitting said trays to be stacked atop one another while restraining relative horizontal movement therebetween.

18. Apparatus as defined in claim 17, further including a plurality of generally L-shaped vertical spacers for stacking selected ones of said trays with vertical space between the selected trays, each of said spacers comprising:
(a) an L-shaped top shaped to mate with the bottom of connecting ones of said side walls of any selected one of said trays; and,
(b) an L-shaped bottom shaped to mate with the top of connecting one of said side walls of any selected other one of said trays.
